(19) United States
(12) Patent Application Publication
(10) Pub. No.: US 2021/0262811 A1
(43) Pub. Date: Aug. 26, 2021

(54) APPARATUSES AND METHODS FOR ENHANCING NAVIGATION

(71) Applicant: AT&T Intellectual Property I, L.P., Atlanta, GA (US)

(72) Inventor: Samuel N. Zellner, Atlanta, GA (US)

(73) Assignee: AT&T Intellectual Property I, L.P., Atlanta, GA (US)

(21) Appl. No.: 16/800,001

(22) Filed: Feb. 25, 2020

(51) Int. Cl. G01C 21/34

(52) U.S. Cl. CPC G01C 21/3415; G05D 1/0088; G01C 21/3461; G01C 21/3492

(57) ABSTRACT

Aspects of the subject disclosure may include, for example, identifying a first user present in a vehicle and a second user present in the vehicle, obtaining, in accordance with the identifying, first preference data from a first record associated with the first user and second preference data from a second record associated with the second user, constructing a route for the vehicle from a first location to a second location in accordance with the first preference data and the second preference data, and subsequent to a navigation of the vehicle along the route, modifying the first preference data in the first record, resulting in modified first preference data, and subsequent to the navigation of the vehicle along the route, maintaining the second preference data in the second record. Other embodiments are disclosed.

### FIELD OF THE DISCLOSURE

The subject disclosure relates to apparatuses and methods for enhancing navigation.

### BACKGROUND

As the world continues to become increasingly connected through vast communication systems and networks, additional opportunities are generated/created for communication devices to assist or facilitate navigation. For example, a user of a smartphone located at a first location (e.g., the user's residence) may enter a second location into an application of the smartphone, where the second location may represent a destination that the user desires to travel to from the first location. In response to receiving the entry, the application may generate one or more recommended routes for the user to travel from the first location to the second location. The application may provide turn-by-turn directions along a selected one of the recommended routes, potentially in conjunction with one or more graphical depictions (e.g., a map) and/or audio outputs (audio instructions regarding turns, exits, etc.). In some instances, the recommended route(s) may be based on traffic conditions along the route(s).

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for provisioning navigation instructions in relation to an operation of a vehicle. Other embodiments are described in the subject disclosure.

One or more aspects of the subject disclosure include obtaining first preference data pertaining to a first user present in a vehicle, second preference data pertaining to a second user present in the vehicle, and third preference data pertaining to non-human cargo present in the vehicle, constructing a route from a first location to a second location based on the first preference data, the second preference data, and the third preference data, generating a guidance interaction along the route, and modifying the guidance interaction in accordance with a determination of the first user's familiarity with the route.

One or more aspects of the subject disclosure include receiving first preference data pertaining to a first user present in a vehicle and second preference data pertaining to non-living cargo present in the vehicle, constructing a route to a first location based on the first preference data and the second preference data, resulting in a constructed route, presenting the constructed route via a display device, a speaker, or a combination thereof, identifying a traffic condition along the route subsequent to the presenting of the constructed route, modifying the route in accordance with the identifying of the traffic condition, resulting in a modified route to the first location, and presenting the modified route via the display device, the speaker, or the combination thereof.

One or more aspects of the subject disclosure include identifying a first user present in a vehicle and a second user present in the vehicle, obtaining, in accordance with the identifying, first preference data from a first record associated with the first user and second preference data from a second record associated with the second user, constructing a route for the vehicle from a first location to a second location in accordance with the first preference data and the second preference data, and subsequent to a navigation of the vehicle along the route, modifying the first preference data in the first record, resulting in modified first preference data, and subsequent to the navigation of the vehicle along the route, maintaining the second preference data in the second record.

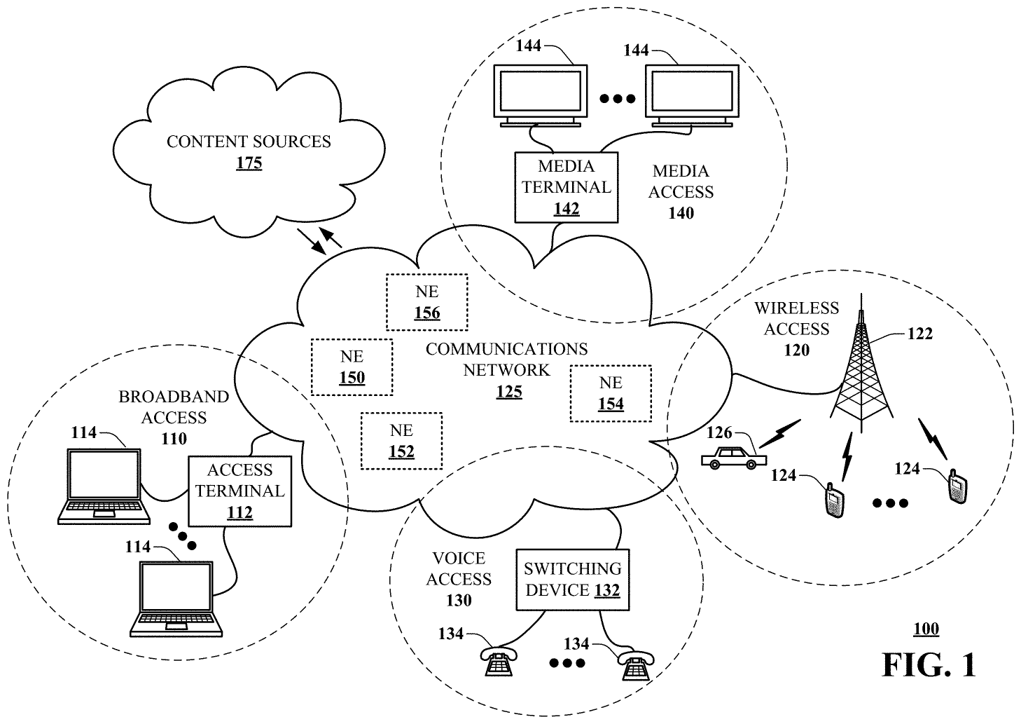

Referring now to FIG. 1, a block diagram is shown illustrating an example, non-limiting embodiment of a system 100 in accordance with various aspects described herein. For example, system 100 can facilitate in whole or in part obtaining first preference data pertaining to a first user present in a vehicle, second preference data pertaining to a second user present in the vehicle, and third preference data pertaining to non-human cargo present in the vehicle, constructing a route from a first location to a second location based on the first preference data, the second preference data, and the third preference data, generating a guidance interaction along the route, and modifying the guidance interaction in accordance with a determination of the first user's familiarity with the route. System 100 can facilitate in whole or in part receiving first preference data pertaining to a first user present in a vehicle and second preference data pertaining to non-living cargo present in the vehicle, constructing a route to a first location based on the first preference data and the second preference data, resulting in a constructed route, presenting the constructed route via a display device, a speaker, or a combination thereof, identifying a traffic condition along the route subsequent to the presenting of the constructed route, modifying the route in accordance with the identifying of the traffic condition, resulting in a modified route to the first location, and presenting the modified route via the display device, the speaker, or the combination thereof. System 100 can facilitate in whole or in part identifying a first user present in a vehicle and a second user present in the vehicle, obtaining, in accordance with the identifying, first preference data from a first record associated with the first user and second preference data from a second record associated with the second user, constructing a route for the vehicle from a first location to a second location in accordance with the first preference data and the second preference data, and subsequent to a navigation of the vehicle along the route, modifying the first preference data in the first record, resulting in modified first preference data, and subsequent to the navigation of the vehicle along the route, maintaining the second preference data in the second record.

In particular, in FIG. 1 a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

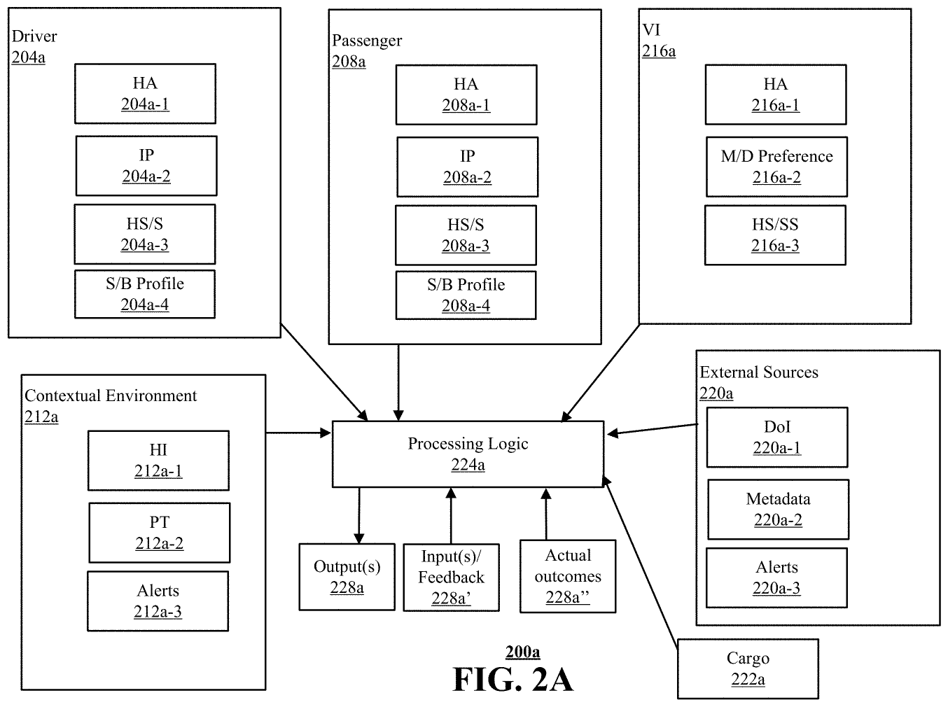

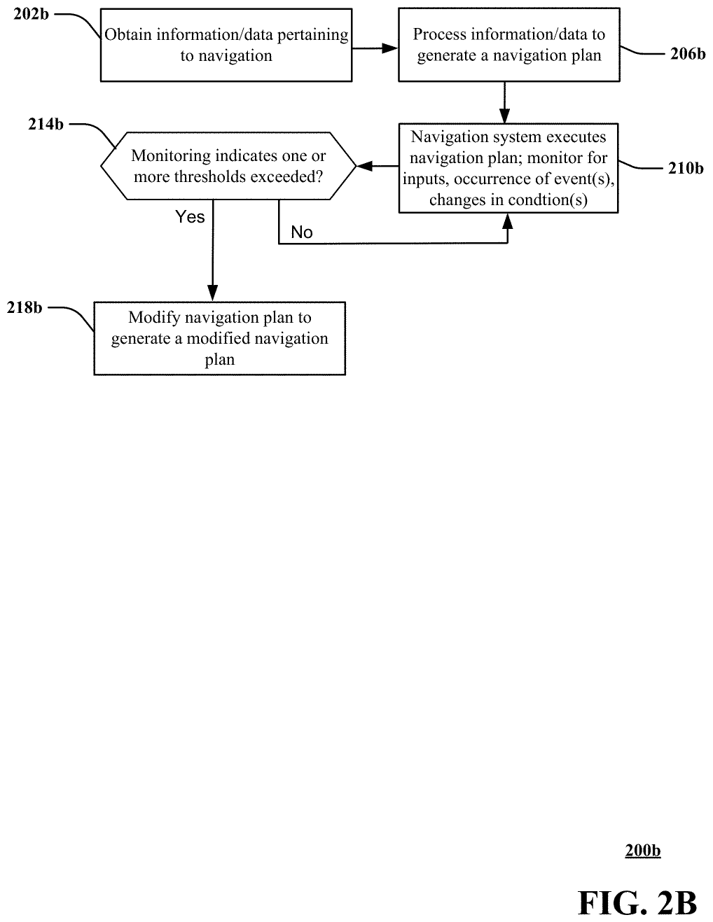

FIG. 2A is a block diagram illustrating an example, non-limiting embodiment of a system 200a functioning within, or operatively overlaid upon, the communication network 100 of FIG. 1 in accordance with various aspects described herein. The system 200a may incorporate aspects of machine learning (ML) and/or artificial intelligence (AI) to enhance an experience (e.g., a user experience) with respect to navigation technologies.

For the sake of illustrative convenience, the system 200a is described below in relation to navigation via an automobile (e.g., a motorcycle, a car, a truck, etc.). Aspects of the system 200a may be implemented in connection with other types of vehicles, including for example spacecraft, aircraft, marine vessels, trains, subways, etc. In addition, the term vehicle includes autonomous vehicles.

As shown in FIG. 2A, the system 200a may include a driver 204a, a passenger 208a, a contextual environment 212a, a vehicle information (VI) 216a, external sources 220a, cargo 222a, and processing logic 224a. One or more (e.g., each) of the driver 204a, the passenger 208a, the contextual environment 212a, the VI 216a, the external sources 220a, and the cargo 222a may be representative of or include, e.g., a computing device (e.g., a server, a computer, a router, a switch, a user device/equipment, etc.), a storage device (e.g., a memory, a drive, a database), etc.

As described in further detail below, the processing logic 224a may be operative on inputs obtained from the driver 204a, the passenger 208a, the contextual environment 212a, the VI 216a, the external sources 220a, or any combination thereof, and may generate one or more outputs 228a. The outputs 228a may include an identification of a recommended (e.g., an optimal) navigation path, navigation instructions (e.g., navigation directions), etc.

Associated with the driver 204a there may be included historical activities (HA) 204a-1, inputted preferences (IP) 204a-2, a health status/schedule (HS/S) 204a-3, a social/behavioral (S/B) profile 204a-4, or any combination thereof. The HA 204a-1 may include historical information or a log/record regarding past trips that a driver of the automobile has engaged in. For example, the HA 204a-1 may include information regarding dates and times of travel, routes taken, velocities or speeds, stops made, etc.

The IP 204a-2 may include information regarding preferences of the driver. The preferences of the driver may be established/generated based on affirmative user inputs (e.g., user responses to questions/queries/prompts, selections from user interfaces such as menus, etc.) and/or may be inferred based on behaviors and/or actions taken (or omitted) by the driver. The preferences of the IP 204a-2 may include information/parameters pertaining to driving conditions, driving dates or times, interaction with guidance features, etc.

The HS/S 204a-3 may include information from one or more applications resident on a communication device (e.g., a cellphone or smartphone, a watch, an Internet of Things [IoT] device, etc.) of the driver. In some embodiments, the HS/S 204a-3 may include information/parameters that may be obtained or derived from applications that may have data at least partially resident on one or more servers (e.g., one or more cloud-based servers). In some embodiments, the HS/S 204a-3 may include calendar information, such as for example parameters associated with a schedule of meetings or travel that the driver has engaged in or is planning to engage in. In some embodiments, the HS/S 204a-3 may include information obtained from one or more communication sessions that the driver has engaged in (e.g., voice packets from a voice call in which the driver indicates that she would prefer to stay home, and not travel, when it is snowing out).

The S/B profile 204a-4 may include information/parameters regarding the driver's preferences in terms of how the driver perceives the world and how the driver makes decisions in response to various conditions or inputs. In some embodiments, the information included in the S/B profile 204a-4 may be obtained or derived from one or more accounts that the driver may have with one or more social media platforms. For example, the information of the S/B profile 204a-4 may be based in part on activities that the driver has undertaken on a social media platform, interactions by (e.g., messages sent by) the driver with contacts (e.g., buddies or friends) on the social media platform, etc. In some embodiments, the information of the S/B profile 204a-4 may be based in part on an identification of media that the driver has consumed (e.g., a news report [e.g., an article, a video, etc.] regarding vehicle maintenance techniques). The information of the S/B profile 204a-4 may be based in part on an identification of a browsing history or purchases made by the driver in connection with one or more goods or services (e.g., a purchase of new windshield wipers for the automobile that the drive operates).

Associated with the passenger 208a there may be included historical activities (HA) 208a-1, inputted preferences (IP) 208a-2, health status/schedule (HS/S) 208a-3, a social/behavioral (S/B) profile 208a-4, or any combination thereof. While described below in the context of a single, given passenger, aspects of the passenger 208a may incorporate information/data/parameters associated with multiple passengers that may be present in the automobile operated by the driver 204a. Such data for the multiple passengers may be represented in the aggregate (such as for example, in connection with an average for all the passengers that may be present in the vehicle), or the data may be broken-down on an individualized basis. Conversely, if one passenger needs to use the restroom every 30 minutes, the lowest common denominator may be the most important for planning the route as opposed to the average.

The HA 208a-1 may include historical information regarding past trips that the passenger of the automobile has engaged in. For example, the HA 208a-1 may include information regarding dates and times of travel, routes taken, velocities or speeds, stops, etc.

The IP 208a-2 may include information regarding preferences of the passenger. The preferences of the passenger may be established/generated based on affirmative user inputs (e.g., user responses to questions/queries/prompts, selections from user interfaces such as menus, etc.) and/or may be inferred based on behaviors and/or actions taken (or omitted) by the passenger. The preferences of the IP 208a-2 may include information/parameters pertaining to driving conditions, driving dates or times, interaction with guidance features, etc. The preferences of the IP 208a-2 may include parameters pertaining to a climate within a cabin of the vehicle, such as for example a preferred temperature of the cabin, a fan speed associated with a climate control system/application, etc. The preferences of the IP 208a-2 may specify parameters associated with an entertainment system/application, such as for example display options associated with a display device, audio options associated with one or more speakers, etc.

The HS/S 208a-3 may include information from one or more applications resident on a communication device (e.g., a cellphone or smartphone, a watch, an Internet of Things [IoT] device, etc.) of the passenger. In some embodiments, the HS/S 208a-3 may include information/parameters that may be obtained or derived from applications that may have data at least partially resident on one or more servers (e.g., one or more cloud-based servers). In some embodiments, the HS/S 208a-3 may include calendar information, such as for example parameters associated with a schedule of meetings or travel that the passenger has engaged in or is planning to engage in. In some embodiments, the HS/S 208a-3 may include information obtained from one or more communication sessions that the passenger has engaged in (e.g., voice packets from a voice call in which the passenger indicates that she would prefer to stay home, and not travel, when it is raining out).

The S/B profile 208a-4 may include information/parameters regarding the passenger's preferences in terms of how the passenger perceives the world and how the passenger makes decisions in response to various conditions or inputs. In some embodiments, the information included in the S/B profile 208a-4 may be obtained or derived from one or more accounts that the passenger may have with one or more social media platforms. For example, the information of the S/B profile 208a-4 may be based in part on activities that the passenger has undertaken on a social media platform, interactions by (e.g., messages sent by) the passenger with contacts (e.g., buddies or friends) on the social media platform, etc. In some embodiments, the information of the S/B profile 208a-4 may be based in part on an identification of media that the passenger has consumed (e.g., a news report [e.g., an article, a video, etc.] regarding safety when riding as a passenger in a vehicle operated by another person). The information of the S/B profile 208a-4 may be based in part on an identification of a browsing history or purchases made by the passenger in connection with one or more goods or services (e.g., a purchase of noise-cancelling headphones that reduce or eliminate background noise when listening to music).

Associated with the contextual environment 212a there may be included historical information (HI) 212a-1, projected trends (PT) 212a-2, and alerts 212a-3. The HI 212a-1 may include information/data/parameters regarding, e.g., historical weather conditions, crime statistics (e.g., a given intersection has demonstrated a propensity for car-hijackings relative to other intersections), statistics regarding accidents in a specific area (e.g., a given intersection has demonstrated a propensity for having collisions relative to other intersections), etc.

The PT 212a-2 may include information/data/parameters regarding trends. For example, the PT 212a-2 may include information related to weather forecasts, agricultural/plant conditions (e.g., pollen forecasts, applications of treatments related to pests or mosquitos, fertilizer application schedules), identifications of special events (e.g., a fair or open-air-market held annually, advertised online or in a printed newspaper, etc.) that may influence traffic patterns, etc.

The alerts 212a-3 may include information/data/parameters regarding warnings that may influence navigation via the automobile. For example, the warnings may be related to weather conditions, governmental warnings (e.g., so-called amber alerts related to missing persons, crime scene investigations, etc.), road closures, fires, utility information (e.g., downed trees or power lines obstructing travel), etc.

The VI 216a may include information/data/parameters related to historical activities (HA) 216a-1, manufacturer/driver (M/D) preferences 216a-2, and health statuses/service schedules (HS/SS) 216a-3. The HA 216a-1 may include information/data/parameters related to past trips of the automobile, such as for example routes that the automobile has traveled. The HA 216a-1 may include a specification/record of service performed on the automobile. The HA 216a-1 may include a specification of (ranges of) operating parameters of the automobile (e.g., engine temperature, oil pressure, battery recharging times).

The M/D preferences 216a-2 may include information/data/parameters related to recommendations that a manufacturer of the automobile (or a device or component of the automobile) has provided in relation to the operation and/or maintenance of the vehicle. For example, the information of the M/D preferences may include a specification of a type of oil to be used, a frequency with which the oil should be changed, driving modes (e.g., 4-wheel or towing), etc. The M/D preferences 216a-2 may include driver preferences, such as for example a driver preference to use regular fuel (as opposed to premium fuel recommended by the manufacturer of the automobile) given a limited budget available to spend on the use of the automobile.

The HS/SS 216a-3 may include information/data/parameters related to the status (e.g., a real-time status) of the automobile and a specification of any need for services. For example, the information of the HS/SS 216a-3 may be useful in connection with a planned trip that would exceed the recommended distance of travel between oil changes. The information of the HS/SS 216a-3 may proactively (e.g., automatically) schedule any needed or desired services with a local dealer or repair/maintenance shop/garage.

The external sources 220a may include information/data/parameters that may be related or relevant to a planning of a trip. For example, the information of the external sources 220a may include, or be obtained or derived from, financial information, news, social media, home security, communication applications or devices, etc. The information of the external sources 220a may be used in a determination of preferences or constraints that may be imposed on the trip. As an example, the driver may have a credit card sponsored by a given provider that is not accepted at a hotel that may be located along the route of the trip.

The external sources 220a may include databases of information (DoI) 220a-1. The DoI 220a-1 may include historical and/or current (e.g., real-time) information. The DoI 220a-1 may include financial information, purchase/shopping information, social media information, etc.

The external sources 220a may include metadata 220a-2. For example, the metadata 220a-2 may include a specification of a (current) location of a contact (e.g., a friend) of the driver on a social media platform. The metadata 220a-2 may also specify that the contact does not live at that location, such that it may be inferred that the contact is visiting the location.

The external sources 220a may include alerts 220a-3 that may impact/influence the trip. For example, news events (e.g., a government official visiting the destination of the trip), financial information (e.g., a stock market crash that may limit available funding for the trip), medical/health information/warnings (e.g., an outbreak of a virus at the destination), security warnings (e.g., a home break-in or invasion that may require the driver's attention and/or the passenger's attention), etc., may be included in the alerts 220a-3.

The processing logic 224a (which may incorporate aspects of hardware, software, firmware, or any combination thereof) may be operative on inputs obtained from (e.g. may be operative on the information/data/parameters provided by) the driver 204a, the passenger 208a, the contextual environment 212a, the VI 216a, the external sources 220a, or any combination thereof, in generating the one or more outputs 228a. The processing logic 224a may combine the inputs it obtains in generating the output(s) 228a using one or more algorithms or techniques. For example, the processing logic 224a may include or provide filtration in order to mitigate the impact of spurious data or conditions. The processing logic 224a may prioritize or weight a first input obtained from the driver 204a relative to a second input obtained from the passenger 208a in order to ensure that the driver is able to operate the automobile safely and comfortably.

The processing logic 224a may generate as an output 228a a navigation plan to facilitate travel from a first location (e.g., a residence, a store, etc.) to a second location (e.g., a residence, a store, etc.) in accordance with the inputs obtained by the processing logic 224a. The navigation plan may be modified or adapted in response to changing conditions, user inputs, an occurrence of one or more events, etc. Decisions or recommendations generated by the processing logic 224a (as represented in the output(s) 228a) may be modified or updated in accordance with user inputs (e.g., user feedback) 228a′ and/or an assessment (e.g., a comparison) between recommended outcomes included in the outputs 228a and actual outcomes 228a″. As an illustrative example, if the driver has a particular preference (as affirmatively specified by the driver or as inferred over time) to drive through rain storms, the system 200a may cease providing alerts (e.g., alerts 212a-3 and/or alerts 220a-3) about the potential impact of rain storms on travel. As the system 200a is used, any errors (actual errors or errors as perceived by a user) may tend to converge to zero over time. As such, as the system 200a gains experience/knowledge via use, such experience/knowledge may encourage/incentivize further, additional use/adoption by the driver and/or a community of users.

Aspects of the system 200a may be used to enhance the navigation experience from a simple route optimization and historical trend prediction to a full blown “virtual chauffer” applicable to traditional, human-operated vehicular travel and self-driving, autonomous vehicles. The system 200a may provide hybrid and dynamic navigation guidance. For example, when in an area or location that a driver is familiar with (e.g., in proximity to a user's home or place of employment), light/little guidance may be provided. However, if the system 200a detects/determines that the driver has likely made an error or mistake, the amount or frequency of the guidance that is provided to the driver may be increased/enhanced. The driver may be queried by the system 200a whether the driver has had a change of plans, and if so, the system 200a may update/modify the navigational guidance in accordance with any feedback or response that is obtained.

As described above, aspects of the system 200a may take into account/consideration the needs or desires of passengers. As an illustrative example, a driver may exit an automobile in order to re-fuel the automobile at a gas station. Conventionally, in many instances the passenger(s) stay in the automobile during such re-fueling. The system 200a may detect that the passenger(s) have been in the vehicle for an extended duration of time (e.g., a duration of time that exceeds a threshold) and may suggest a re-fueling stop/bathroom-break/snack-or-meal break on the basis thereof. Such a detection may be based on the use of one or more sensors, such as for example a sensor in a seat, a door, etc.

Aspects of the system 200a may enhance the efficiency of driving or otherwise operating a vehicle. For example, recommendations or suggestions regarding a navigation plan/itinerary may be based on reducing (e.g., minimizing) a number of stops that are made along a route from a first location to a second location. The recommendations or suggestions may be tailored to preferences of the driver or passengers. As an illustrative example, a driver may have a preference for tying re-fueling stops to meal stops at specified restaurants and staying at lodging (e.g., a hotel, a motel, a bed-and-breakfast, etc.) that charges less than a threshold amount of money per night, while also avoiding travel at night (e.g., between the hours of 8 PM and 5 AM). The recommendations/suggestions may be based at least in part on the specified preference(s).

Aspects of the system 200a may take into consideration needs or requirements associated with cargo 222a transported by a vehicle. For example, if the driver stopped at a grocery store and purchased a perishable product (e.g., ice cream), and if the outside temperature is 35 degrees Celsius, the system 200a may recommend that the driver return home before traveling to work so that the perishable product does not perish (e.g., melt, spoil, etc.). The knowledge that the user purchased a perishable product may be established via a linkage with the grocery store, querying the driver what was purchased, etc. In another example, if the cargo 222a is a child or a pet, the system 200a may alert the driver that the child/pet is in the backseat to avoid catastrophic consequences (e.g., leaving the child/pet in a stuffy car on a summer day with the windows completely rolled up for more than a threshold amount of time). One or more sensors may be consulted/utilized to detect the presence of the child/pet in the backseat. In this respect, in some embodiments the cargo 222a may include one or more living beings and/or non-living beings (e.g., non-humans).

Aspects of the system 200a may enhance (e.g., optimize) a trip or activities in accordance with a user schedule. For example, if a driver is running errands around town in the morning and needs to pick up her son after school in the afternoon at 3 PM, the system 200a may schedule a re-fueling stop at 2:30 PM in order to be at the school no later than 2:55 PM. The re-fueling stop may be at a petrochemical/gas station, a(n electric vehicle) recharging station, etc., depending on the type of vehicle.

Aspects of the system 200a may provide suggestions/recommendations regarding points of interest that may be of interest to a user (e.g., a driver, a passenger, etc.). For example, if a driver of an automobile has an interest in art, the system 200a may recommend that the user stop in at a museum that is located 2 miles off of a (main) route from a starting point and a destination. The system 200a may further indicate the impact that stopping at the museum may have, such as for example “the typical touring time at the museum is one hour, such that the time spent there will likely not jeopardize arriving at your hotel before dusk” or “the typical touring time at the museum is one hour; you should use the restroom/bathroom there so that I can eliminate the next scheduled stop to ensure you arrive at your hotel before dusk.” As another illustrative use case, the system 200a may monitor a medical sensor (e.g., a heart monitor) and suggest that the driver stop at an urgent-care clinic if the driver's heart rate exceeds a threshold. As yet another example, the system 200a may monitor tire pressure relative to miles traveled between tire replacements and suggest stopping at a service station to get the tires checked and/or replaced. For example, the system 200a may annunciate: “Based on the outputs of my sensors, the automobile appears to be experiencing a problem with the driver-side front tire. The local garage at exit 78 off of this highway has a four-star customer approval rating and will provide a 10% discount on any services provided in relation to the tires. Note that the current tires are only rated for 30,000 miles of use, and this automobile has been driven 35,000 miles since the tires were last replaced. The local garage typically charges a $50 tire repair fee.”

Aspects of the system 200a may incorporate preferences regarding road type (e.g., highway, local, surface [paved versus dirt/gravel]) in generating recommendations/suggestions regarding a navigation/travel plan or itinerary. Aspects of the system 200a may incorporate historical data with predictions on when and where a user (e.g., a driver) is likely to travel as part of formulating/generating a navigation plan. Aspects of the system 200a may implement crowd-sourcing to identify events or conditions, such as for example accidents or road closures that may impact travel, and generate and/or update a navigation plan accordingly.

Aspects of the system 200a my incorporate employment/company data, weather information, information that identifies an amount or type of cargo, purpose of trip/navigation (e.g., pleasure versus business), etc., in generating and/or adjusting/modifying a navigation plan. The navigation plan may be based at least in part on a specification of a vehicle type or performance, a vehicle status (e.g., time between maintenance/service, age of vehicle, etc.), etc. In some embodiments, a navigation plan may be generated and/or adapted based on preferences regarding: time/day of travel, duration of travel, level/extent of driver or passenger engagement/interaction (e.g., to avoid the driver falling asleep behind the steering wheel/steering column), eating frequency, gas/battery charge capacity/level, restaurants, lodging, attractions, etc.

FIG. 2B depicts an illustrative embodiment of a method 200b in accordance with various aspects described herein. The method 200b may be at least partially executed in conjunction with one or more systems, devices, and/or components, such as for example the systems, devices, and components described herein. As an illustrative example, the method 200b may be at least partially executed by the processing logic 224a of FIG. 2A. Aspects of the method 200b may be executed to generate and/or modify a navigation plan associated with a trip via a (selected) vehicle.

In block 202b, information/data pertaining to navigation may be obtained. For example, and briefly referring to FIG. 2A, the information/data obtained as part of block 202b may be acquired from the driver 204a, the passenger 208a, the contextual environment 212a, the VI 216a, the external sources 220a, or any combination thereof.

The information/data obtained as part of block 202b may be in response to a request. For example, a user may enter a request as part of an application executing on one or more communication devices, where the request may specify an intention to travel from a first location (e.g., a current location or an originating location) to a second location (e.g., a destination).

In some embodiments, the information/data obtained as part of block 202b may be in accordance with an occurrence of an event. For example, if a user historically/typically goes grocery shopping at a grocery store on Tuesday afternoons, but this Tuesday afternoon the user has to pick her child up from school as represented/reflected by an entry submitted to a calendar application by the user (or another user), the submission of the entry may invoke the execution of block 202b.

In block 206b, the information/data obtained as part of block 202b may be processed to generate a navigation plan. The navigation plan may include, e.g., a specification of one or more paths (e.g., roadways) to take, a recommended vehicle to take in view of service needed on one or more vehicles, conditions of the one or more paths, a recommended speed of travel (e.g., to avoid sun glare, glare from oncoming vehicle lights, storms, etc.), recommended stops along the path, identifications of points/sites of interest, recommended media to be presented during travel (e.g., documentaries about wine-making if the navigation entails traveling through Napa Valley), recommended communication devices to take on the trip, etc. Briefly referring back to FIG. 2A, the navigation plan of block 206b may be included/represented by the output(s) 228a.

The navigation plan of block 206b may be stored by one or more communication devices. The navigation plan of block 206b may be presented by the one or more communication devices. For example, the navigation plan may be presented via one or more graphical representations (e.g., in accordance with a map, with turn-by-turn directions potentially overlaid thereupon), textual representations (e.g., a textual listing of turn-by-turn directions referenced to distances traveled), audio representations (e.g., audio turn-by-turn directions/instructions referenced to distance to a given turn), etc.

In block 210b, the vehicle and/or a navigation system may begin to execute the navigation plan, potentially in conjunction with one or more inputs provided by a user (e.g., a driver). As part of block 210b, one or more inputs (e.g., user inputs) may be monitored. Briefly referring to FIG. 2A, the one or more inputs that are monitored may include the feedback 228′. Alternatively and/or additionally, as part of block 210b, an occurrence (or an omission) of events and/or changes in conditions may be monitored. Briefly referring to FIG. 2A again, the occurrence/omission of the events and/or changes in conditions may be encapsulated or incorporated within the actual outcomes 228″.

An extent or frequency of any monitoring that may be performed in conjunction with block 210b may be based on a specified user preference and/or may be selected so as to provide a sufficient degree of update to the navigation plan (as described in further detail below) while at the same time avoiding unnecessarily distracting or bothering the user. In this respect, one or more thresholds may be established or utilized to control the extent or duration of any monitoring (block 210b) and/or updating (block 218b) that may be performed as described further below.

In block 214b, a determination may be made whether the monitoring of block 210b indicates that one or more thresholds is exceeded. If the determination is such that the one or more thresholds are not exceeded, flow may return from block 214b to block 210b. In this respect, a loop may be established to continue monitoring against/relative to the navigation plan established in block 206b. On the other hand, if the determination in block 214b is such that the one or more thresholds are exceeded, flow may proceed from block 214b to block 218b.

In block 218b, the navigation plan of block 206b may be modified/updated in accordance with the monitoring of block 210b, resulting in a modified navigation plan. As an illustrative example, if as part of block 210b the user is forced to slow the vehicle down for five miles due to unexpected traffic congestion (which may be a result of an accident, for example), a determination may be made that the user will not make it to first lodging specified in the navigation plan of block 206b before sundown. In this respect, the modified navigation plan of block 218b may cancel a reservation associated with the first lodging and may order/place a reservation associated with second lodging that is in closer proximity to the site of the accident.

While not specifically shown in FIG. 2B, following the execution of block 218b, flow may proceed from block 218b to block 210b. As part of the flow from block 218b to block 210b, the navigation plan (of block 210b) may be replaced by the modified navigation plan of block 218b. Stated slightly differently, any updates/modifications to a given navigation plan may result in further monitoring being performed relative to the updates/modifications. In this respect, a navigation plan may be updated/modified in (substantially) real-time in response to changing inputs, events, and/or conditions.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Aspects of the disclosure may enhance/incorporate privacy considerations when generating and/or modifying one or more outputs, such as for example a navigation plan. For example, in an embodiment where a first user and a second user are participating in a navigation plan, a first user's participation in the navigation plan might not be included or incorporated as part of a first record, whereas the second user's participation may be included/incorporated as part of a second record. In this respect, the first user may be able to derive/obtain the benefits of using the navigation technologies of this disclosure while avoiding generating any record or footprint of participating in or utilizing the same.

As described herein, aspects of the disclosure may facilitate a provisioning of assistance to an operator (e.g., a driver) of a vehicle. Aspects of the disclosure may facilitate semi-autonomous and fully autonomous vehicle operations. In some embodiments, one or more users/persons present in a vehicle may be passengers of the vehicle. For example, aspects of the disclosure may be implemented/incorporated as part of one or more ride-sharing applications that may be executed by one or more communication devices, such as a mobile device. In some embodiments, a given user may request service via the execution of such applications.

As described herein, aspects of this disclosure may tailor guidance that is provided to a first user in accordance with the first user's familiarity with a (constructed) route. The first user's familiarity with the route may be based on one or more of: historical travel data, user feedback (from the first user, one or more other users, or any combination thereof) during navigation along the route, and mistakes made in navigating the route.

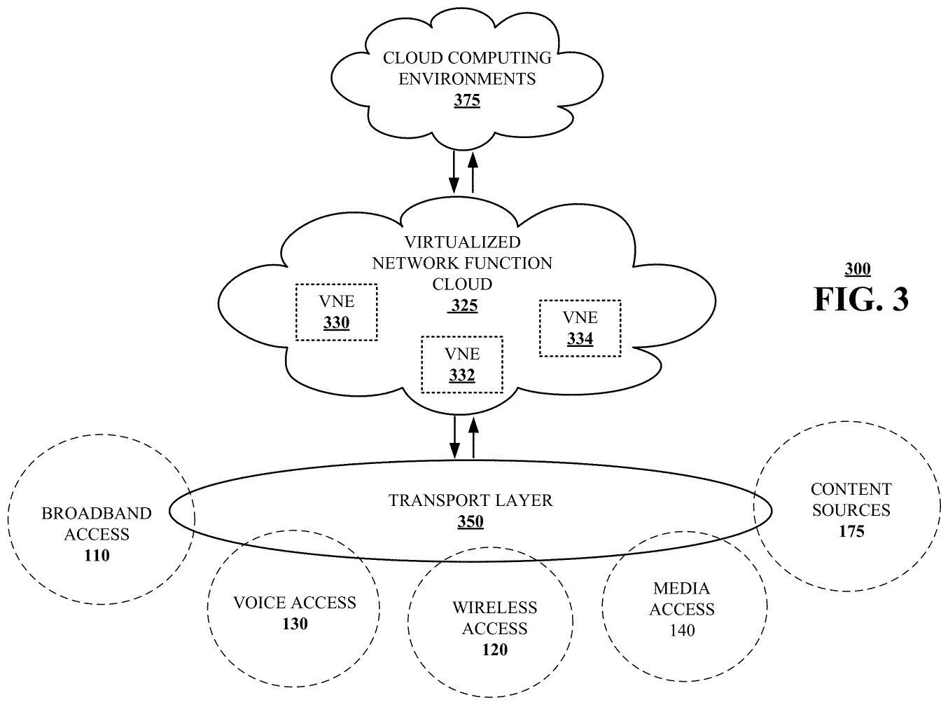

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200a, and method 200b presented in FIGS. 1, 2A, and 2B. For example, virtualized communication network 300 can facilitate in whole or in part obtaining first preference data pertaining to a first user present in a vehicle, second preference data pertaining to a second user present in the vehicle, and third preference data pertaining to non-human cargo present in the vehicle, constructing a route from a first location to a second location based on the first preference data, the second preference data, and the third preference data, generating a guidance interaction along the route, and modifying the guidance interaction in accordance with a determination of the first user's familiarity with the route. Virtualized communication network 300 can facilitate in whole or in part receiving first preference data pertaining to a first user present in a vehicle and second preference data pertaining to non-living cargo present in the vehicle, constructing a route to a first location based on the first preference data and the second preference data, resulting in a constructed route, presenting the constructed route via a display device, a speaker, or a combination thereof, identifying a traffic condition along the route subsequent to the presenting of the constructed route, modifying the route in accordance with the identifying of the traffic condition, resulting in a modified route to the first location, and presenting the modified route via the display device, the speaker, or the combination thereof. Virtualized communication network 300 can facilitate in whole or in part identifying a first user present in a vehicle and a second user present in the vehicle, obtaining, in accordance with the identifying, first preference data from a first record associated with the first user and second preference data from a second record associated with the second user, constructing a route for the vehicle from a first location to a second location in accordance with the first preference data and the second preference data, and subsequent to a navigation of the vehicle along the route, modifying the first preference data in the first record, resulting in modified first preference data, and subsequent to the navigation of the vehicle along the route, maintaining the second preference data in the second record.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

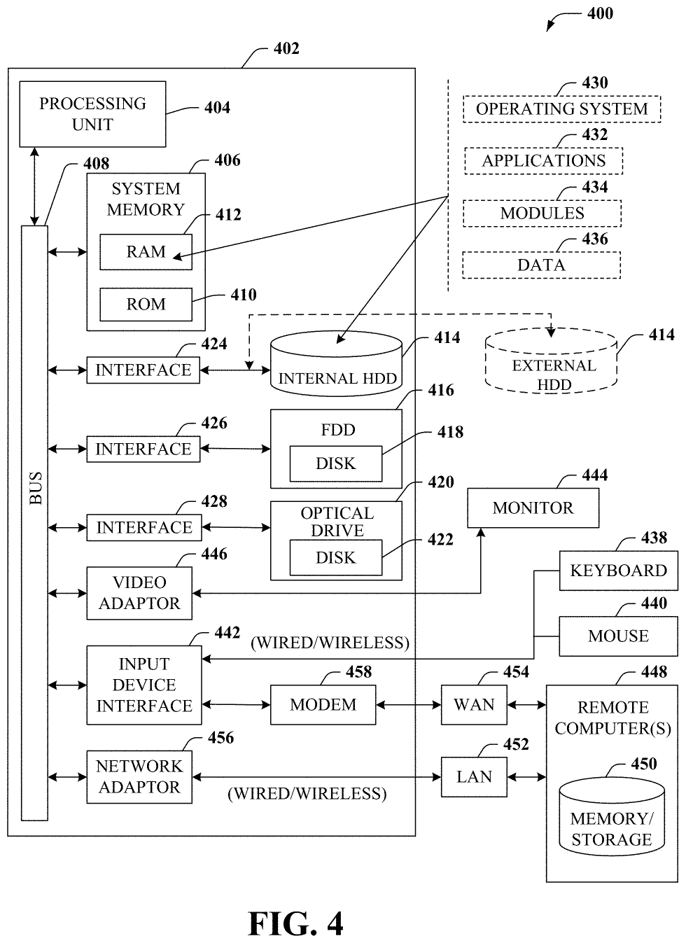

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part obtaining first preference data pertaining to a first user present in a vehicle, second preference data pertaining to a second user present in the vehicle, and third preference data pertaining to non-human cargo present in the vehicle, constructing a route from a first location to a second location based on the first preference data, the second preference data, and the third preference data, generating a guidance interaction along the route, and modifying the guidance interaction in accordance with a determination of the first user's familiarity with the route. Computing environment 400 can facilitate in whole or in part receiving first preference data pertaining to a first user present in a vehicle and second preference data pertaining to non-living cargo present in the vehicle, constructing a route to a first location based on the first preference data and the second preference data, resulting in a constructed route, presenting the constructed route via a display device, a speaker, or a combination thereof, identifying a traffic condition along the route subsequent to the presenting of the constructed route, modifying the route in accordance with the identifying of the traffic condition, resulting in a modified route to the first location, and presenting the modified route via the display device, the speaker, or the combination thereof. Computing environment 400 can facilitate in whole or in part identifying a first user present in a vehicle and a second user present in the vehicle, obtaining, in accordance with the identifying, first preference data from a first record associated with the first user and second preference data from a second record associated with the second user, constructing a route for the vehicle from a first location to a second location in accordance with the first preference data and the second preference data, and subsequent to a navigation of the vehicle along the route, modifying the first preference data in the first record, resulting in modified first preference data, and subsequent to the navigation of the vehicle along the route, maintaining the second preference data in the second record.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM),flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

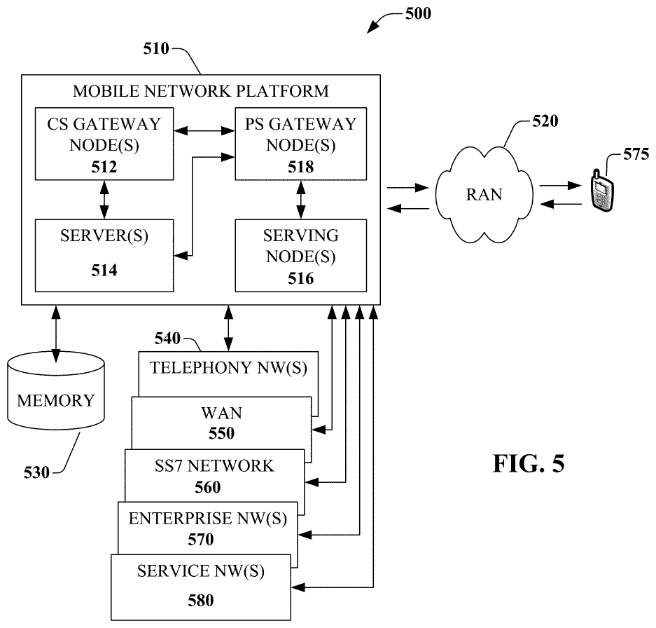

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part obtaining first preference data pertaining to a first user present in a vehicle, second preference data pertaining to a second user present in the vehicle, and third preference data pertaining to non-human cargo present in the vehicle, constructing a route from a first location to a second location based on the first preference data, the second preference data, and the third preference data, generating a guidance interaction along the route, and modifying the guidance interaction in accordance with a determination of the first user's familiarity with the route. Platform 510 can facilitate in whole or in part receiving first preference data pertaining to a first user present in a vehicle and second preference data pertaining to non-living cargo present in the vehicle, constructing a route to a first location based on the first preference data and the second preference data, resulting in a constructed route, presenting the constructed route via a display device, a speaker, or a combination thereof, identifying a traffic condition along the route subsequent to the presenting of the constructed route, modifying the route in accordance with the identifying of the traffic condition, resulting in a modified route to the first location, and presenting the modified route via the display device, the speaker, or the combination thereof. Platform 510 can facilitate in whole or in part identifying a first user present in a vehicle and a second user present in the vehicle, obtaining, in accordance with the identifying, first preference data from a first record associated with the first user and second preference data from a second record associated with the second user, constructing a route for the vehicle from a first location to a second location in accordance with the first preference data and the second preference data, and subsequent to a navigation of the vehicle along the route, modifying the first preference data in the first record, resulting in modified first preference data, and subsequent to the navigation of the vehicle along the route, maintaining the second preference data in the second record.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

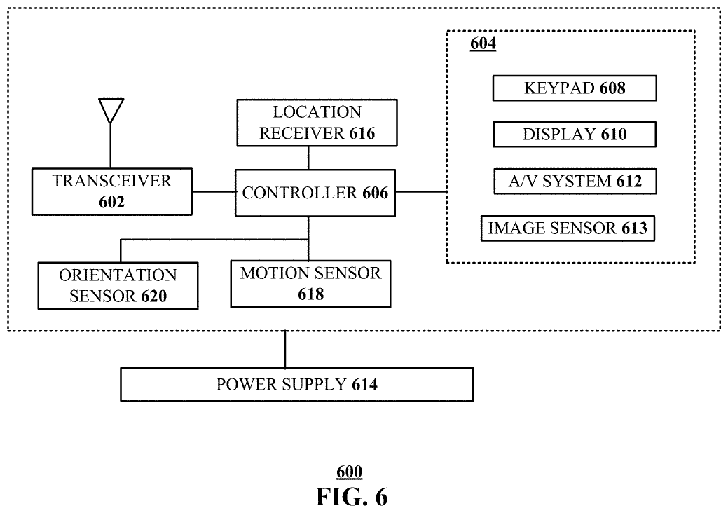

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part obtaining first preference data pertaining to a first user present in a vehicle, second preference data pertaining to a second user present in the vehicle, and third preference data pertaining to non-human cargo present in the vehicle, constructing a route from a first location to a second location based on the first preference data, the second preference data, and the third preference data, generating a guidance interaction along the route, and modifying the guidance interaction in accordance with a determination of the first user's familiarity with the route. Computing device 600 can facilitate in whole or in part receiving first preference data pertaining to a first user present in a vehicle and second preference data pertaining to non-living cargo present in the vehicle, constructing a route to a first location based on the first preference data and the second preference data, resulting in a constructed route, presenting the constructed route via a display device, a speaker, or a combination thereof, identifying a traffic condition along the route subsequent to the presenting of the constructed route, modifying the route in accordance with the identifying of the traffic condition, resulting in a modified route to the first location, and presenting the modified route via the display device, the speaker, or the combination thereof. Computing device 600 can facilitate in whole or in part identifying a first user present in a vehicle and a second user present in the vehicle, obtaining, in accordance with the identifying, first preference data from a first record associated with the first user and second preference data from a second record associated with the second user, constructing a route for the vehicle from a first location to a second location in accordance with the first preference data and the second preference data, and subsequent to a navigation of the vehicle along the route, modifying the first preference data in the first record, resulting in modified first preference data, and subsequent to the navigation of the vehicle along the route, maintaining the second preference data in the second record.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
obtaining first preference data pertaining to a first user present in a vehicle, second preference data pertaining to a second user present in the vehicle, and third preference data pertaining to non-human cargo present in the vehicle;
constructing a route from a first location to a second location based on the first preference data, the second preference data, and the third preference data;
generating a guidance interaction along the route; and
modifying the guidance interaction in accordance with a determination of the first user's familiarity with the route.

2. The device of claim 1, wherein the determination of the first user's familiarity with the route is based on: historical travel data, feedback during navigation along the route from the first user, the second user, or a combination thereof, mistakes made in navigating the route, or any combination thereof.

3. The device of claim 1, wherein the constructing of the route is further based on maintenance data associated with the vehicle.

4. The device of claim 3, wherein the maintenance data pertains to a recharging of a battery associated with the vehicle, a level of a fuel tank of the vehicle, an oil change performed on the vehicle, a tire repair or replacement performed on the vehicle, or any combination thereof.

5. The device of claim 1, wherein the first user is a driver of the vehicle and the second user is a passenger of the vehicle.

6. The device of claim 1, wherein the first user and the second user are passengers in the vehicle.

7. The device of claim 6, wherein the first user requested the vehicle via a ride-sharing application executed by a mobile device.

8. The device of claim 6, wherein the vehicle is an autonomous vehicle and the first user is a passenger in the vehicle.

9. The device of claim 1, wherein the first preference data comprises an indication of a restaurant, lodging, or a combination thereof.

10. The device of claim 1, wherein the second preference data comprises an indication of a temperature in a cabin of the vehicle, a display capability of a display device present in the vehicle, and an audio capability of a speaker present in the vehicle.

11. The device of claim 1, wherein the constructing of the route is further based on crime statistics, statistics regarding accidents, a weather forecast, a road closure, utility information, and an agricultural condition.

12. The device of claim 1, wherein the constructing of the route is further based on financial information, medial information, a home security warning, or any combination thereof.

13. The device of claim 1, wherein the operations further comprise:
identifying a point of interest to the first user, the second user, or a combination thereof, wherein the point of interest is located at a third location along the route between the first location and the second location;
presenting a first indication of the point of interest to the first user, the second user, or the combination thereof;
presenting a second indication of an impact that stopping at the point of interest will have on navigation along the route via the vehicle to the first user, the second user, or the combination thereof;
obtaining a user-generated input that indicates an acceptance of the point of interest;
modifying the route in accordance with the user-generated input, resulting in a modified route; and
presenting the modified route to the first user, the second user, or the combination thereof.

14. The device of claim 1, wherein the operations further comprise:
modifying a first record associated with the first user in accordance with a navigation of the vehicle along the route to capture a traversal of the first user along the route; and
maintaining a second record associated with the second user to avoid capturing the traversal of the second user along the route via the navigation of the vehicle.

15. A machine-readable medium, comprising executable instructions that, when executed by a processing system including a processor, facilitate performance of operations, the operations comprising:
receiving first preference data pertaining to a first user present in a vehicle and second preference data pertaining to non-living cargo present in the vehicle;
constructing a route to a first location based on the first preference data and the second preference data, resulting in a constructed route;
presenting the constructed route via a display device, a speaker, or a combination thereof;
identifying a traffic condition along the route subsequent to the presenting of the constructed route;
modifying the route in accordance with the identifying of the traffic condition, resulting in a modified route to the first location; and
presenting the modified route via the display device, the speaker, or the combination thereof.

16. The machine-readable medium of claim 15, wherein the non-living cargo comprises a perishable product purchased from a store located at a second location, and wherein the operations further comprise:
identifying the first location as corresponding to a residence of the first user, wherein the route is from the second location to the first location.

17. The machine-readable medium of claim 15, wherein the operations further comprise:
obtaining a user-generated input from a communication device of the first user responsive to the presenting of the modified route;
modifying the modified route in accordance with the user-generated input, resulting in a second modified route;
presenting the second modified route via the display device, the speaker, or the combination thereof; and
modifying the first preference data in accordance with the user-generated input, resulting in modified first preference data.

18. The machine-readable medium of claim 17, wherein the display device, the speaker, or the combination thereof, is integrated in the vehicle, wherein the obtaining of the user-generated input from the communication device comprises obtaining the user-generated input from a social media application executed by the communication device, and wherein the operations further comprise:
constructing a second route to a second location based on the modified first preference data.

19. A method, comprising:
identifying, by a processing system including a processor, a first user present in a vehicle and a second user present in the vehicle;
obtaining, by the processing system and in accordance with the identifying, first preference data from a first record associated with the first user and second preference data from a second record associated with the second user;
constructing, by the processing system, a route for the vehicle from a first location to a second location in accordance with the first preference data and the second preference data; and
subsequent to a navigation of the vehicle along the route, modifying, by the processing system, the first preference data in the first record, resulting in modified first preference data; and
subsequent to the navigation of the vehicle along the route, maintaining, by the processing system, the second preference data in the second record.

20. The method of claim 19, wherein the constructing of the route for the vehicle from the first location to the second location comprises generating a prediction regarding a time when the vehicle will arrive at the second location, resulting in a predicted time;
the method further comprising:
determining, by the processing system, an actual time when the vehicle arrives at the second location;
generating, by the processing system, an identification of an error based on a comparison between the predicted time and the actual time;
obtaining, by the processing system, crowd-sourced information from a plurality of client devices; and
constructing, by the processing system, a second route for the vehicle to a third location in accordance with the modified first preference data, the identification of the error, and the crowd-sourced information.
